(19) United States
(12) Patent Application Publication
(10) Pub. No.: US 2005/0269796 A1
(43) Pub. Date: Dec. 8, 2005

(54) Controlling power-hop in a vehicle

(76) Inventors: Thomas J. Sawarynski, Redford, MI (US); Richard C. Fleming, Lapeer, MI (US); Michael J. Corbin, Rochester Hills, MI (US); Steven P. Lyman, Canton, MI (US); Richard A. Myers, Waterford, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 10/860,696

(22) Filed: Jun. 3, 2004

(51) Int. Cl. B60G 11/46; B60G 11/02

(52) U.S. Cl. 280/124.174; 280/124.156

(57) ABSTRACT

A method and apparatus are provided for controlling power hop in a Hotchkiss-type vehicle suspension having a live axle housing supported by a left and right suspension leaf spring, through the use of a pair of half-leaf springs adapted for operative attachment at a rear end thereof to the left and right terminal ends respectively of the axle housing, and a damping device adapted for operative attachment between a chassis of the vehicle and the rear axle housing. The half-leaf spring members extend longitudinally in a forward direction, below and generally in vertical alignment with their respectively associated suspension leaf spring, and are spaced therefrom, with the forward end of each half-spring member including a snubber for contacting a lower surface of the associated suspension leaf spring and terminating below and adjacent the forward end of its respectively associated suspension leaf spring.

### TECHNICAL FIELD OF THE INVENTION

This invention relates to vehicular suspensions for rear wheel drive vehicles, and more particularly to Hotchkiss-type vehicle suspensions.

### BACKGROUND OF THE INVENTION

For many decades, rear wheel drive motor vehicles, such as automobiles, trucks, busses and industrial vehicles, have utilized Hotchkiss-type drive and suspension arrangements, as shown in FIGS. 1-3. In a typical Hotchkiss drive and suspension 100, a rear drive axle housing 102 is attached to the vehicle chassis 104 by arcuate-shaped leaf springs 106, which control both the springing and location of the axle housing 102 with respect to the chassis 104. The axle housing 102 includes a differential housing 108, enclosing a differential having ring and planet gears (not shown), and a drive pinion (not shown) engaging the planet gear. The differential is connected to the rear wheels 110 via axle shafts (not shown) extending through the axle housing 102. The differential also includes an articulated input 112, connected to the pinion, and adapted for connection through a driveshaft 114 to the transmission (not shown) of the vehicle.

The leaf springs 106 are pivotably attached at the forward ends 116 thereof, through a pin arrangement, to the chassis 104, so that the forward ends 116 cannot move longitudinally forward or rearward with respect to the chassis 104. The rear ends 118 of the leaf springs 106 are attached to the chassis 104 through an articulated link 120, which allows the rear ends 118 of the leaf springs 106 to move longitudinally with respect to the chassis 104 as the leaf springs 106 bend or flex. By having the ends 116, 118 of the leaf springs 106 attached in this manner, the rear ends 118 of one or both of the springs 106 can move longitudinally through action of the articulated link 120, as load is applied to the leaf springs 106 by the chassis 104, to thereby allow the leaf springs 106 to bend or flex away from an unloaded position and apply spring action for supporting the chassis 104.

When the vehicle is cornering, the load is shifted through body roll to the leaf spring 106 supporting the end of the axle housing 102 that is farthest from the center of the turning arc of the vehicle. As the load shifts outward, the outer leaf spring 106, assumes a flatter arcuate shape than the inner leaf spring 106. Because the front ends 116 of the leaf springs 106 are fixed and cannot move longitudinally, and because the axle housing 102 is fixedly attached to the leaf springs 106 at a middle point thereof, the outer end of the axle housing 102 pivots transversely backward with respect to the inner end of the axle housing 102, as the outer leaf spring flattens under the load imposed by body roll. This rearward pivoting of the outer end of the axle housing 102 during turning causes the wheels attached to the axle housing 102 to track better during the turn, and is an inherent and advantageous characteristic of the Hotchkiss-type suspension 100.

Another inherent characteristic of the Hotchkiss suspension 100 is the tendency of the input 112 of the axle housing to pivot upward or downward, as shown in FIGS. 2 and 3, which causes the leaf springs 106 to wind-up and assume an S-shape, under high torque launch, or braking of the vehicle. As shown in FIG. 3, as braking force is applied to the wheels 110 through braking devices (not shown) attached to the outer ends of the axle housing 102, while the vehicle is moving forward and the wheels are rotating in the direction shown by arrow 122, the input 112 of the axle housing 102 is caused to pivot downward, by the braking force. This downward pivoting of the input 112 causes the leaf springs 106 to assume an S shape that is advantageous to braking, in that the springs 106 generate a force that causes the contact point of the wheel 110 to dig into the road surface in a manner that resists further forward motion of the vehicle. If the vehicle is traveling backward when the brakes are applied, the axle housing 102 will be rotated in the opposite direction, as is illustrated in FIG. 2.

Under extreme braking, where the wheels 110 lose traction, the energy stored in the springs 106 can cause them to snap back from the S shape, and generate a phenomenon known as axle hop. Under normal loading and operating conditions, however, axle hop during braking can generally be precluded by judicious design of the suspension components, and the rotation of the axle housing provides another advantageous inherent characteristic of the Hotchkiss suspension.

Under a high power launch of the vehicle, when high torque is being applied to the input 112 of the axle housing 102, such as might occur in a vehicle attempting to accelerate at a full throttle condition from a stop, the pinion will tend to climb the ring gear inside of the differential housing 118, and the input 112 will rotate upward, as shown in FIG. 2, which will in turn cause the leaf springs to assume an extreme S shaped condition. If the wheels 110 should lose traction, by virtue of the applied power and RPM being so high as to overcome friction between the wheels 110 and the road surface, the leaf springs 106 will snap back from the S shaped condition, and may do so in a manner that causes the wheels 100 to actually hop slightly off of the road surface, and cause a condition known as power hop. If power is applied continuously, the wind-up and release of energy in the leaf springs 106 will be repeated in an oscillatory manner, which will cause traction to be available only intermittently, and generate undesirable forces and wear on the suspension components and tread surfaces of the wheels 110.

From the forgoing, it will be understood that the Hotchkiss suspension provides desirable inherent characteristics with regard to enhancing performance during turning and braking of a vehicle, but that the inherent characteristic of power hop is undesirable.

In certain types of vehicles that are typically operated under high power launch conditions, such as drag racers or off-road vehicles, a pair of devices that are commonly known as “slapper bars” have been used in the past to reduce power hop. As shown, in FIG. 4, slapper bars 124 are longitudinally extending rigid beams 126 or truss-like members, that are secured at their rear ends to the axle housing 102 adjacent respective points of attachment of the leaf springs 106. The beams 126 extend forward in vertical alignment with the leaf springs 106. The forward ends of the beams 126 are equipped with bumper elements 128, or shackles (not shown), having one or more thrust surfaces 130 that contact the lower surfaces, and in some instances also the upper surfaces of the beams 126, to resist wind up of the springs 106 during a high power launch of the vehicle. U.S. Pat. No. 3,897,844, to Chevalier, and U.S. Pat. No. 4,282,945, to Bessey, disclose such slapper bar devices.

While slapper bars 124 do reduce power hop and increase traction, in specialty vehicles such as dragsters or off-road vehicles, they negatively impact performance of the Hotchkiss suspension in ways that make them impractical for use in normal driving circumstances. Because the slapper bars 124 are very rigid, there is a substantial and abrupt change in the feel and handling of the vehicle when the bumper elements 128 of the slapper bars 124 come into contact with the leaf springs 106. While the noticeable change in feel and handling is acceptable to the driver of a dragster or an off-road vehicle, it can be very disconcerting to an average driver of a passenger vehicle being operated under normal road driving conditions.

The slapper bars 126 also tend to undesirably come into contact with the outer leaf spring 106 as the vehicle body attempts to sway outward during a turn, thereby nullifying the desirable inherent steering characteristics of the Hotchkiss-type suspension. If the contact surfaces 130 of the bumper elements 128 or shackles of the slapper bars 124 are adjusted close enough to the springs 106 to be effective in reducing power hop, the bumper element 128 or shackle slapper bar 124 on the outer spring 106 will contact the outer spring 106 as the vehicle body sways in a turn, and may cause the rear wheels of the vehicle to hop sideways during the turn, thereby resulting in an undesirable loss of control during the turn.

Slapper bars 124, of the type disclosed by Bessey, for example, that have shackles which also contact the top surfaces of the leaf springs 106, nullify the desirable inherent capability of the leaf springs 106 of Hotchkiss-type suspension to wind up in a manner that enhances braking, as described above and illustrated in FIG. 3.

Some slapper bars 124 include provisions for manually increasing the spacing between the leaf springs 106 and the thrust surfaces 130 of the bumper elements 128 or shackles of the beams 126 of the slapper bars 124, to reduce the negative characteristics of the slapper bars 124 during normal driving conditions, but in doing so, the effectiveness of the slapper bars 124 in resisiting power hop is reduced. It is also highly impractical and undesirable in a typical passenger vehicle regularly operated under normal driving conditions to require that the slapper bars 124 continually be manually readjusted for different driving conditions.

What is needed is an improved method and apparatus for controlling power hop in a Hotchkiss-type suspension, that overcome one or more of the problems discussed above.

### SUMMARY OF THE INVENTION

The invention provides an improved method and apparatus for controlling power hop in a Hotchkiss-type vehicle suspension having a live axle housing supported by a left and right suspension leaf spring, through the use of a pair of half-leaf springs adapted for operative attachment at a rear end thereof to the left and right terminal ends respectively of the axle housing. The half-leaf spring members extend longitudinally in a forward direction, below and generally in vertical alignment with their respectively associated suspension leaf spring, and are spaced therefrom, with the forward end of each half-spring member terminating below and adjacent the forward end of its respectively associated suspension leaf spring. A snubber element is attached to a forward end of each half-spring element, and includes a thrust surface for contacting the respectively associated suspension leaf spring when the respectively associated suspension leaf spring is been bent or flexed sufficiently to move the associated suspension leaf spring into contact with the snubber on the half-leaf spring member.

The method and apparatus may also utilize a damping device adapted for operative attachment between a chassis of the vehicle and the rear axle housing.

The half-leaf springs may consist essentially of a single flexible leaf. The apparatus and method may further include a splay limiter attached to each half-leaf spring, with the splay limiter having a contact surface thereof adapted to be operatively disposed in a spaced relation to an upper surface of the suspension leaf spring respectively associated therewith, for contacting the upper surface of the suspension leaf spring when the suspension leaf spring is bent or flexed sufficiently to bring the upper surface of the suspension leaf spring into contact with the contact surface of the splay limiter.

The invention may also take the form of a method for controlling power hop, by using an apparatus as described above.

The half-springs and damper of the invention provide a softer and more gradual contact against the suspension leaf springs than slapper bars, and also provide a gradual application of force for resisting wind-up of the suspension leaf springs, in a manner that is virtually imperceptible to occupants and the driver of the vehicle under all vehicle operating conditions, including turning and braking.

The foregoing and other features and advantages of the invention will become further apparent from the following detailed description of exemplary embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIGS. 1-3 are schematic representations illustrating the components and performance characteristics of a prior Hotchkiss-type suspension during high-power launch and braking;

FIG. 4 is a side view of a prior art device known as a slapper bar attached to a vehicle suspension;

FIG. 5 is a side view of an exemplary embodiment of a vehicle suspension, including an apparatus for resisting power hop, according to the invention, having a portion of a frame rail cut away to better illustrate components and aspect of the invention;

FIG. 6 is a perspective view of the exemplary embodiment of a vehicle suspension, shown in FIG. 5; and

FIG. 7 is an enlarged partial perspective view of a splay limiter, according to the invention.

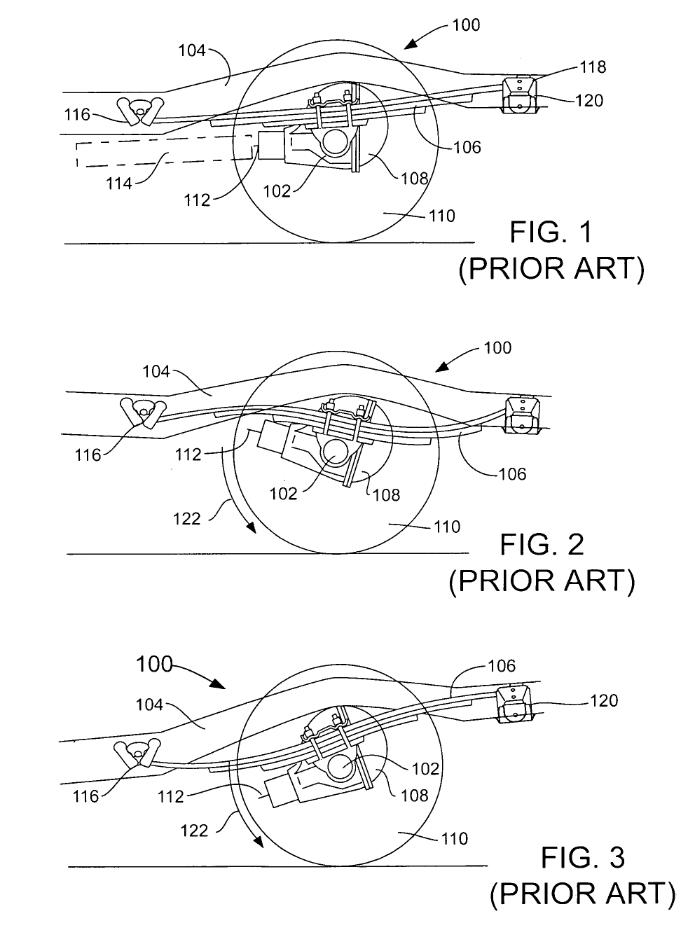

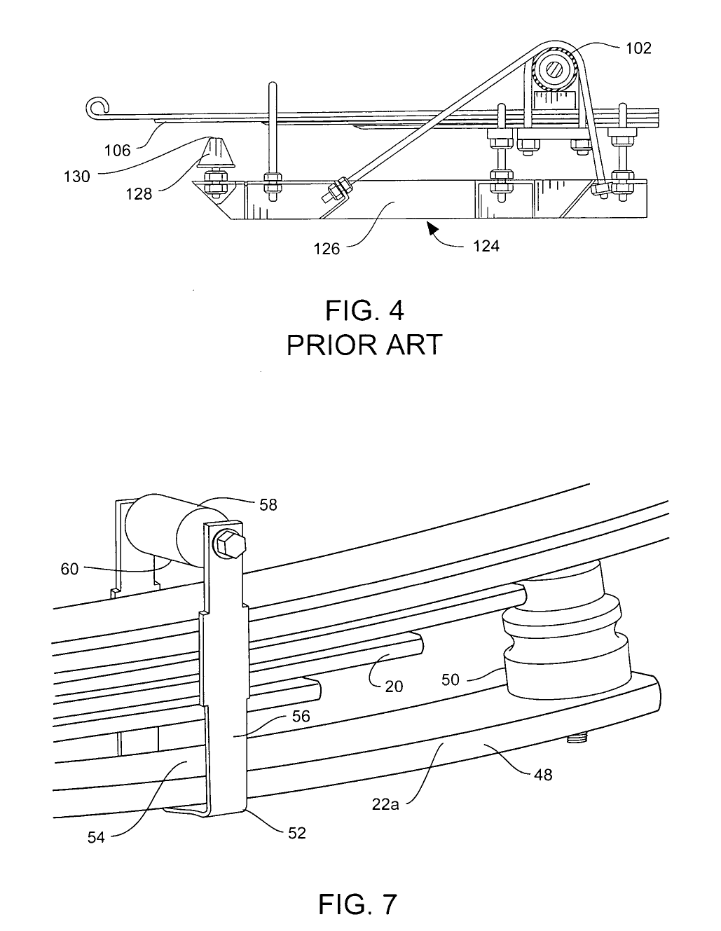

### DETAILED DESCRIPTION

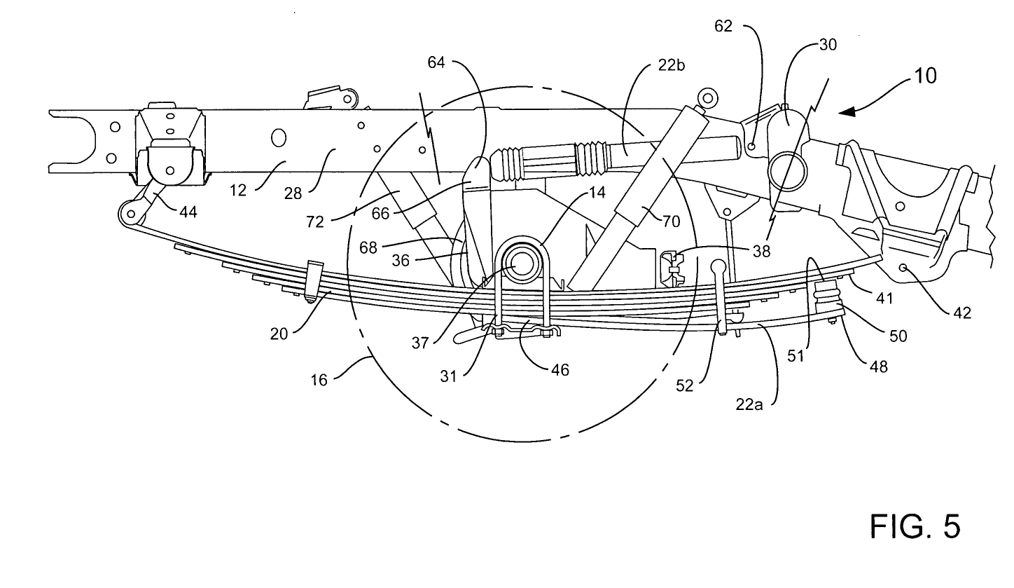

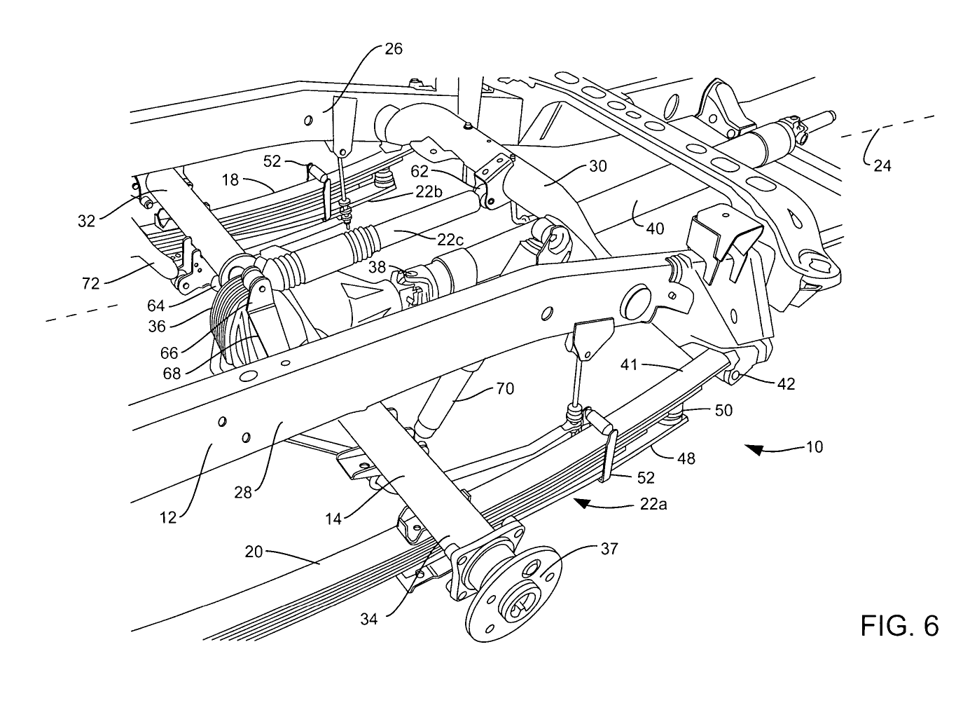

FIGS. 5 and 6 show an exemplary embodiment of a vehicle suspension 10, according to the invention. The vehicle suspension 10 includes a chassis 12, a drive axle housing 14, a pair of ground engaging wheels 16, a left and a right rear suspension leaf spring 18, 20, and an apparatus 22a, 22b, 22c for resisting power hop.

As shown in FIG. 6, the chassis 12 defines a longitudinal axis 24 extending from a forward end to a rearward end of the vehicle, and includes a pair of juxtaposed left and right side rails 26, 28 disposed on opposite sides of the longitudinal axis 24. The chassis 12 also includes a crossmember 30 disposed at a point on the chassis 12 forward of the drive axle housing 14.

The drive axle housing 14 extends transversely to the longitudinal axis 24 and defines a left and a right terminal end 32, 34 of the axle housing 14. The axle housing 14 includes a differential housing 36, enclosing a differential having ring and planet gears (not shown), and a drive pinion (not shown) engaging the planet gear. The differential is connected to the rear wheels 16 via axles 37 extending through the axle housing 14. The differential also includes an articulated input 38, operatively connected to be driven by the pinion, and adapted for connection through a driveshaft 40 to the transmission (not shown) of the vehicle.

As shown in FIG. 5, the axles 37 are rotatable in the axle housing for driving the ground engaging rear wheels 16.

As shown in FIGS. 5 and 6, the left and right leaf longitudinally extending suspension springs 18, 20 are each attached at middle points thereof, by U-bolts 31 (shown in FIG. 5 only), to the axle housing 14, adjacent the left and right terminal ends 32, 34 of the axle housing 14. The forward ends 41 of the left and right suspension leaf springs 18, 20 are pivotably attached to the chassis 12 by pins, as shown at 42 in FIGS. 5 and 6, so that the forward ends 41 cannot move longitudinally forward or rearward with respect to the chassis 12.

As shown in FIG. 5, the rear ends of the left and right suspension leaf springs 18, 20 are each operatively attached to the chassis 12 by an articulating link 44 that allows for longitudinal movement of the rear ends of the suspension leaf springs 18, 20, with respect to the chassis 12, when the leaf springs 18, 20 are bending or flexing with respect to the chassis 12.

The apparatus for resisting power-hop includes three main elements, a right half-leaf spring 22a, a left half-leaf spring 22b, and a damping device 22c.

The rear ends 46 of the left and a right half-leaf springs 22b, 22a are attached, by the U-bolts 31, to the left and right terminal ends 32, 34 respectively of the axle housing 14, adjacent the middle points of the suspension leaf springs 18, 20. The half-leaf spring members 22a, 22b extend longitudinally in a forward direction, below and generally in vertical alignment with their respectively associated suspension leaf spring 20, 18, and are spaced therefrom, with the forward end 48 of each half-spring members 22a, 22b terminating below and adjacent the forward end 41 of its respectively associated suspension leaf spring 18, 20.

A snubber element 50 of a resilient material, such as rubber, is attached to the forward end 48 of each half-spring element 22a, 22b. The snubber elements 50 have a thrust surface 51 for contacting the respectively associated suspension leaf spring 18, 20 when the respectively associated suspension leaf spring 18, 20 is been bent or flexed sufficiently to move the associated suspension leaf spring 18, 20 into contact with the thrust surface 51 of the snubber 50 of one or both of the half-leaf spring members 22a, 22b.

In the exemplary embodiment of the vehicle suspension 10 the half-leaf springs consist essentially of a single flexible leaf. Such a single-leaf configuration is generally contemplated as being preferred, but in other embodiments of the invention it may be desirable to use multiple leaves to form each of the half-leaf springs 22a, 22b.

The Exemplary embodiment of the vehicle suspension 10 includes a splay limiter 52 attached, by a rivet 54 to each half-leaf spring 22a, 22b, as shown in FIG. 7. The splay limiter 52 includes a generally U-shaped bracket 56, having the bight attached by the rivet 54 to the lower surface of the half-leaf springs 22a, 22b. The legs of the U-shaped bracket 56 extend upward along the inboard and outboard sides of the associated suspension leaf spring 18, 20 to help position the half-leaf springs 22a, 22b, and the multiple leaves of the suspension leaf springs 18, 20 in a longitudinal direction. The upper open end of the U-shaped bracket 56 is closed by a roller 58 of resilient material, such as rubber, having a contact surface 60 thereof operatively disposed in a spaced relation to an upper surface of the suspension leaf spring 18, 20 respectively associated therewith, for contacting the upper surface of the suspension leaf spring 18, 20 when the suspension leaf spring 18, 20 is bent or flexed sufficiently to bring the upper surface of the suspension leaf spring 18, 20 into contact with the contact surface 60 of the roller 58 of the spay limiter 52. In addition to keeping the leaves of the suspension leaf springs 18, 20 and the half-leaf springs 22a, 22b aligned longitudinally, the splay limiter prevents the front ends 48 of the half-leaf springs 22a, 22b from dipping too low during a braking event, due to downward rotation of the input 38 of the axle housing 14.

The damping device 22c of the exemplary embodiment is a monotube fluid damper having a first and a second input 62, 64 thereof attached respectively to the crossmember 30 of the chassis 12 and a bracket 66 extending from the rear cover 68 of the differential housing 36 of the axle housing 14, for resisting rotation of the axle housing 14 with respect to the chassis 12. The mono-tube fluid damper 22c defines a linear axis thereof and is mounted with the linear axis of the mono-tube damper extending generally parallel to the longitudinal axis 28 of the chassis 12, at a location above the articulated input 38 and drive shaft 40.

It will be noted that the exemplary embodiment of the vehicle suspension 10 also includes a pair of shock absorbers 70, 72, operatively attached between the axle housing 14 and the chassis 12, for damping up and down movement of the axle housing 14 with respect to the chassis 12.

Those skilled in the art will readily recognize that, while the embodiments of the invention disclosed herein are presently considered to be preferred, various changes and modifications can be made without departing from the spirit and scope of the invention. For example, the half springs 22a, 22b and snubbers 50 can be utilized without the damper 22c or splay limiters 52 in other embodiments of the invention. The snubbers 50 may alternatively be bonded to the half-leaf springs 22a, 22b, or be formed integrally with the forward ends 48 of the half-leaf springs 22a, 22b. Where the snubbers 50 are formed integrally with the half-leaf springs 22a, 22b they may be either resilient or non-resilient.

Those having skill in the art will also recognize that the invention may be practiced as part of an O.E.M. vehicle, or in an aftermarket apparatus.

The scope of the invention is indicated in the appended claims, and all changes or modifications within the meaning and range of equivalents are intended to be embraced therein.

1. An apparatus for resisting power-hop in a vehicle having a chassis defining a longitudinal axis extending from a forward end to a rearward end of the vehicle, a drive axle housing extending transversely to the longitudinal axis and defining a left and a right terminal end of the axle housing, a pair of ground engaging rear wheels driven by axles rotatable in the axle housing, a left and a right longitudinally extending suspension leaf spring attached at middle points thereof to the axle housing adjacent the left and right terminal ends of the axle housing and defining a forward and a rear end of the left and right suspension leaf springs respectively, the forward ends of the left and right suspension leaf springs being pivotably attached to the chassis and the rear ends of the left and right suspension leaf springs being operatively attached to the chassis for longitudinal movement with respect to the chassis when the leaf springs are bending or flexing with respect to the chassis, the apparatus for resisting power-hop comprising:
a left and a right half-leaf spring defining a forward and a rear end thereof, adapted for operative attachment at the rear ends thereof to the left and right terminal ends respectively of the axle housing, adjacent the middle points of the suspension leaf springs, with the half-leaf spring members extending longitudinally in a forward direction, below and generally in vertical alignment with their respectively associated suspension leaf spring, and spaced therefrom, with the forward end of each half-spring member terminating below and adjacent the forward end of its respectively associated suspension leaf spring; and
a pair of snubber elements, one attached to the forward end of each half-spring element, and having a thrust surface for contacting the respectively associated suspension leaf spring when the respectively associated suspension leaf spring is been bent or flexed sufficiently to move the associated suspension leaf spring into contact with the half-leaf spring member.

2. The apparatus of claim 1 wherein the half-leaf springs consist essentially of a single flexible leaf.

3. The apparatus of claim 1 further comprising a splay limiter attached to each half-leaf spring and having a contact surface thereof adapted to be operatively disposed in a spaced relation to an upper surface of the suspension leaf spring respectively associated therewith, for contacting the upper surface of the suspension leaf spring when the suspension leaf spring is bent or flexed sufficiently to bring the upper surface of the suspension leaf spring into contact with the contact surface of the splay limiter.

4. The apparatus of claim 1, further comprising a damping device adapted for operative attachment between the chassis and the rear axle housing.

5. The apparatus of claim 4 wherein the damping device comprises a fluid damper having a first and a second input thereof adapted for attachment to the chassis and the axle housing respectively, for resisting rotation of the axle housing with respect to the chassis.

6. The apparatus of claim 5 wherein the fluid damper is a mono-tube fluid damper defining a linear axis thereof and adapted to be mounted with the linear axis extending generally parallel to the longitudinal axis of the chassis.

7. The apparatus of claim 6 wherein:
the axle housing includes a differential housing disposed between the left and right terminal ends of the axle housing, and having a forward facing articulated input for receiving driving torque from a longitudinally extending drive shaft; and
the mono-tube damper is adapted for mounting at a location above the articulated input and drive shaft.

8. An method for resisting power-hop in a vehicle having a chassis defining a longitudinal axis extending from a forward end to a rearward end of the vehicle, a drive axle housing extending transversely to the longitudinal axis and defining a left and a right terminal end of the axle housing, a pair of ground engaging rear wheels driven by axles rotatable in the axle housing, a left and a right longitudinally extending suspension leaf spring attached at middle points thereof to the axle housing adjacent the left and right terminal ends of the axle housing and defining a forward and a rear end of the left and right suspension leaf springs respectively, the forward ends of the left and right suspension leaf springs being pivotably attached to the chassis and the rear ends of the left and right suspension leaf springs being operatively attached to the chassis for longitudinal movement with respect to the chassis when the leaf springs are bending or flexing with respect to the chassis, the method for resisting power-hop comprising:
operatively attaching a left and a right half-leaf spring defining a forward and a rear end thereof, at the rear ends thereof to the left and right terminal ends respectively of the axle housing, adjacent the middle points of the suspension leaf springs, with the half-leaf spring members extending longitudinally in a forward direction, below and generally in vertical alignment with their respectively associated suspension leaf spring, and spaced therefrom, with the forward end of each half-spring member terminating below and adjacent the forward end of its respectively associated suspension leaf spring; and
attaching a snubber element having a thrust surface to the forward end of each half-spring element, with the thrust surface disposed in a spaced relationship to the respectively associated suspension spring for contacting the respectively associated suspension leaf spring when the respectively associated suspension leaf spring is been bent or flexed sufficiently to move the associated suspension leaf spring into contact with the half-leaf spring member.

9. The method of claim 8 further comprising fabricating the half-leaf springs to consist essentially of a single flexible leaf.

10. The method of claim 8 further comprising attaching to each half-leaf spring a retainer having a contact surface thereof operatively disposed in a spaced relation to an upper surface of the suspension leaf spring respectively associated therewith, for contacting the upper surface of the suspension leaf spring when the suspension leaf spring is bent or flexed sufficiently to bring the upper surface of the suspension leaf spring into contact with the contact surface of the snubber.

11. The method of claim 8, further comprising, operatively attaching a damping device between the chassis and the rear axle housing.

12. The method of claim 11 wherein the damping device comprises a fluid damper having a first and a second input thereof, and the method further comprises attaching the first and second inputs of the fluid damper to the chassis and the axle housing respectively, for resisting rotation of the axle housing with respect to the chassis.

13. The method of claim 12 wherein the fluid damper is a mono-tube fluid damper defining a linear axis thereof, and the method further comprises, mounting the fluid damper with the linear axis extending generally parallel to the longitudinal axis of the chassis.

14. The method of claim 13 wherein, the axle housing includes a differential housing disposed between the left and right terminal ends of the axle housing, and having a forward facing articulated input for receiving driving torque from a longitudinally extending drive shaft, and the method further comprises disposing the mono-tube damper above the articulated input and drive shaft.

15. A vehicle suspension comprising:
a chassis defining a longitudinal axis extending from a forward end to a rearward end of the vehicle;
a drive axle housing extending transversely to the longitudinal axis and defining a left and a right terminal end of the axle housing;
a pair of ground engaging rear wheels driven by axles rotatable in the axle housing;
a left and a right longitudinally extending suspension leaf spring attached at middle points thereof to the axle housing adjacent the left and right terminal ends of the axle housing and defining a forward and a rear end of the left and right suspension leaf springs respectively, the forward ends of the left and right suspension leaf springs being pivotably attached to the chassis and the rear ends of the left and right suspension leaf springs being operatively attached to the chassis for longitudinal movement with respect to the chassis when the leaf springs are bending or flexing with respect to the chassis;
and an apparatus for resisting power-hop comprising:
a left and a right half-leaf spring defining a forward and a rear end thereof, operatively attachment at the rear ends thereof to the left and right terminal ends respectively of the axle housing, adjacent the middle points of the suspension leaf springs, with the half-leaf spring members extending longitudinally in a forward direction, below and generally in vertical alignment with their respectively associated suspension leaf spring, and spaced therefrom, with the forward end of each half-spring member terminating below and adjacent the forward end of its respectively associated suspension leaf spring; and
a pair of snubber elements, one attached to the forward end of each half-spring element, and having a thrust surface for contacting the respectively associated suspension leaf spring when the respectively associated suspension leaf spring is been bent or flexed sufficiently to move the associated suspension leaf spring into contact with the half-leaf spring member.

16. The vehicle suspension of claim 15 wherein the half-leaf springs consists essentially of a single flexible leaf.

17. The vehicle suspension of claim 15 further comprising a retainer attached to each half-leaf spring and having a contact surface thereof operatively disposed in a spaced relation to an upper surface of the suspension leaf spring respectively associated therewith, for contacting the upper surface of the suspension leaf spring when the suspension leaf spring is bent or flexed sufficiently to bring the upper surface of the suspension leaf spring into contact with the contact surface of the snubber.

18. The vehicle suspension of claim 15, further comprising a damping device operatively attached between the chassis and the rear axle housing.

19. The vehicle suspension of claim 18 wherein the damping device comprises a fluid damper having a first and a second input thereof attached to the chassis and the axle housing respectively, for resisting rotation of the axle housing with respect to the chassis.

20. The vehicle suspension of claim 19 wherein the fluid damper is a mono-tube fluid damper defining a linear axis thereof mounted with the linear axis extending generally parallel to the longitudinal axis of the chassis.

21. The vehicle suspension of claim 6 wherein:
the axle housing includes a differential housing disposed between the left and right terminal ends of the axle housing, and having a forward facing articulated input for receiving driving torque from a longitudinally extending drive shaft; and
the mono-tube damper is adapted for mounting at a location above the articulated input and drive shaft.
